(19) United States
(12) Patent Application Publication
(10) Pub. No.: US 2014/0269906 A1
(43) Pub. Date: Sep. 18, 2014

(54) MOVING IMAGE ENCODING APPARATUS, METHOD FOR CONTROLLING THE SAME AND IMAGE CAPTURING APPARATUS

(71) Applicant: CANON KABUSHIKI KAISHA, Tokyo (JP)

(72) Inventor: Koji Togita, Yokohama-shi (JP)

(73) Assignee: CANON KABUSHIKI KAISHA, Tokyo (JP)

(21) Appl. No.: 14/187,417

(22) Filed: Feb. 24, 2014

(30) Foreign Application Priority Data
Mar. 15, 2013 (JP) 2013-054131

(51) Int. Cl. H04N 19/126; H04N 19/176; H04N 19/196; H04N 19/139

(52) U.S. Cl. CPC H04N 19/00096; H04N 19/00151; H04N 19/00278; H04N 19/00369
USPC 375/240.03

(57) ABSTRACT

There is provided a moving image encoding apparatus configured to perform encoding using motion compensation and quantization. A first dividing unit divides a coding target image into a plurality of first block images. A second dividing unit divides the first block image into a plurality of second block images. A characteristic amount calculating unit calculates, for each of the plurality of second block images, a characteristic amount. A selecting unit, if a degree of variation in the characteristic amounts of the plurality of second block images is greater than or equal to a threshold value, selects the plurality of second block images, and if not, selects the first block image. An encoding unit encodes the plurality of second block images or the first block image in accordance with the selection performed by the selecting unit.

### BACKGROUND OF THE INVENTION

1. Field of the Invention

The present invention relates to a moving image encoding apparatus, a method for controlling the same, and an image capturing apparatus.

2. Description of the Related Art

In recent years, video cameras have started being produced which perform High-Definition (HD) recording using a disk medium, a hard disk, a memory, or the like as a recording medium. These video cameras are small, easy to carry, and can record videos with high image quality, and therefore it is believed that they will become more and more widely-used in the future. This type of camera stores a video in a recording medium using a video stream that has undergone compression encoding in accordance with MPEG4 part-10:AVC (ISO/IEC 14496-10, also known as H.264) for example in order to perform HD recording. With this compression encoding method, inter-frame prediction (inter-prediction) that uses correlations between images, and intra-frame prediction (intra-prediction) that uses correlations within an image are used along with arithmetic coding, and thereby compression encoding is performed with high efficiency.

Also, there is a technique for realizing an improvement in the encoding efficiency by varying the size of blocks for performing quantization and motion prediction at the time of compression encoding. One motion vector is included per block, and therefore, if the block size is increased, the number of motion vectors can be decreased in comparison to the case of reducing the block size. Because of this, the encoding amount can be reduced. On the other hand, if the block size is reduced, it is possible to set motion vectors and quantization steps that are more appropriate for the respective blocks. Therefore, encoding efficiency can be improved by switching the block size according to the characteristics of the input video.

Japanese Patent Laid-Open No. 9-130801 discloses an image encoding apparatus that uses this kind of technique. The image encoding apparatus disclosed in Japanese Patent Laid-Open No. 9-130801 divides an input video into smaller regions and calculates motion vectors in the divided regions, and if there is a small difference between the motion vectors of a certain block and an adjacent block, a size obtained by combining the block and the adjacent block is used as the block size. This reduces the number of vectors, and improves the encoding efficiency.

With the configuration of the above-described prior technology, the block size is determined using only the motion vectors. In this case, if the block size increases, the number of vectors will be reduced, but on the other hand, there is an increased likelihood that a complex region and a flat region will exist in the same block. A block needs to be quantized uniformly, and therefore if a complex region and a flat region are both present in the same block, the quantization step needs to be set uniformly for the complex region and the flat region. Accordingly, there is a problem in that if the quantization step size is increased, image quality deterioration will be noticeable in the flat region, and if the quantization step size is decreased, the amount of generated code will increase in the complex region and the encoding efficiency will decrease.

### SUMMARY OF THE INVENTION

The present invention has been created in view of the above-mentioned situation and provides a technique for reducing the number of motion vectors while suppressing image quality deterioration in encoding using motion compensation and quantization.

According to a first aspect of the present invention, there is provided a moving image encoding apparatus configured to perform encoding using motion compensation and quantization, the moving image encoding apparatus comprising: a first dividing unit configured to divide a coding target image into a plurality of first block images; a motion vector detecting unit configured to detect a motion vector of the first block image; a second dividing unit configured to divide the first block image into a plurality of second block images; a characteristic amount calculating unit configured to calculate, for each of the plurality of second block images, a characteristic amount that indicates noticeability of image quality deterioration caused by quantization; a selecting unit configured to, if a degree of variation in the characteristic amounts of the plurality of second block images is greater than or equal to a threshold value, select the plurality of second block images, and if not, select the first block image; and an encoding unit configured to encode the plurality of second block images or the first block image in accordance with the selection performed by the selecting unit.

According to a second aspect of the present invention, there is provided a moving image encoding apparatus configured to perform encoding using motion compensation and quantization, the moving image encoding apparatus comprising: a first dividing unit configured to divide a coding target image into a plurality of first block images; a second dividing unit configured to divide the first block image into a plurality of second block images; a characteristic amount calculating unit configured to, for each of the plurality of second block images, calculate a characteristic amount of an image; a size determining unit configured to determine whether to use a size of the first block image or a size of the second block image as an encoding size of the first block image; and an encoding unit configured to encode the first block image using the size of the first block image or the size of the second block image in accordance with the determination by the size determining unit, wherein, based on the characteristic amounts of the plurality of second block images calculated by the characteristic amount calculating unit, if each of the plurality of second block images is a flat region, the size determining unit determines the size of the first block image as the encoding size of the first block image.

According to a third aspect of the present invention, there is provided a moving image encoding apparatus configured to perform encoding using motion compensation and quantization, the moving image encoding apparatus comprising: a first dividing unit configured to divide a coding target image into a plurality of first block images; a second dividing unit configured to divide the first block image into a plurality of second block images; a characteristic amount calculating unit configured to, for each of the plurality of second block images, calculate a characteristic amount of an image; a size determining unit configured to determine whether to use a size of the first block image or a size of the second block image as an encoding size of the first block image; and an encoding unit configured to encode the first block image using the size of the first block image or the size of the second block image in accordance with the determination by the size determining unit, wherein, based on the characteristic amounts of the plurality of second block images calculated by the characteristic amount calculating unit, if the plurality of second block images include a flat region and a complex region, the size determining unit determines the size of the second block image as the encoding size of the first block image.

According to a fourth aspect of the present invention, there is provided a method for controlling a moving image encoding apparatus configured to perform encoding using motion compensation and quantization, the method comprising: a first dividing step of dividing a coding target image into a plurality of first block images; a motion vector detecting step of detecting a motion vector of the first block image; a second dividing step of dividing the first block image into a plurality of second block images; a characteristic amount calculating step of, for each of the plurality of second block images, calculating a characteristic amount that indicates noticeability of image quality deterioration caused by quantization; a selecting step of, if a degree of variation in the characteristic amounts of the plurality of second block images is greater than or equal to a threshold value, selecting the plurality of second block images, and if not, selecting the first block image; and an encoding step of encoding the plurality of second block images or the first block image in accordance with the selection in the selecting step.

According to a fifth aspect of the present invention, there is provided a method for controlling a moving image encoding apparatus configured to perform encoding using motion compensation and quantization, the method comprising: a first dividing step of dividing a coding target image into a plurality of first block images; a second dividing step of dividing the first block image into a plurality of second block images; a characteristic amount calculating step of, for each of the plurality of second block images, calculating a characteristic amount of an image; a size determining step of determining whether to use a size of the first block image or a size of the second block image as an encoding size of the first block image; and an encoding step of encoding the first block image using the size of the first block image or the size of the second block image in accordance with the determination in the size determining step, wherein in the size determining step, based on the characteristic amounts of the plurality of second block images calculated in the characteristic amount calculating step, if each of the plurality of second block images is a flat region, the size of the first block image is determined as the encoding size of the first block image.

According to a sixth aspect of the present invention, there is provided a method for controlling a moving image encoding apparatus configured to perform encoding using motion compensation and quantization, the method comprising: a first dividing step of dividing a coding target image into a plurality of first block images; a second dividing step of dividing the first block image into a plurality of second block images; a characteristic amount calculating step of, for each of the plurality of second block images, calculating a characteristic amount of an image; a size determining step of determining whether to use a size of the first block image or a size of the second block image as an encoding size of the first block image; and an encoding step of encoding the first block image using the size of the first block image or the size of the second block image in accordance with the determination in the size determining step, wherein in the size determining step, based on the characteristic amounts of the plurality of second block images calculated in the characteristic amount calculating step, if the plurality of second block images include a flat region and a complex region, the size of the second block image is determined as the encoding size of the first block image.

Further features of the present invention will become apparent from the following description of exemplary embodiments with reference to the attached drawings.

### BRIEF DESCRIPTION OF THE DRAWINGS

FIG. 1 is a block diagram showing a configuration of a moving image encoding apparatus 100 according to a first embodiment.

FIG. 2 is a diagram for describing a first block image.

FIG. 3 is a diagram for describing a second block image.

FIG. 4 is a flowchart showing encoding processing performed by the moving image encoding apparatus 100.

FIG. 5 is a diagram showing a specific example of encoding processing performed by the moving image encoding apparatus 100 according to the first embodiment.

FIG. 6 is a block diagram showing a configuration of a moving image encoding apparatus 600 according to a second embodiment.

FIG. 7 is a diagram for describing motion vector detection processing performed by a motion search unit 601 according to the second embodiment.

FIG. 8 is a diagram showing a specific example of encoding processing performed by the moving image encoding apparatus 600 according to the second embodiment.

### DESCRIPTION OF THE EMBODIMENTS

Embodiments of the present invention will now be described with reference to the attached drawings. It should be noted that the technical scope of the present invention is defined by the claims, and is not limited by any of the embodiments described below. In addition, not all combinations of the features described in the embodiments are necessarily required for realizing the present invention.

### First Embodiment

FIG. 1 is a block diagram showing a configuration of a moving image encoding apparatus 100 according to a first embodiment. The moving image encoding apparatus 100 is configured to divide an input video (moving image) into blocks of variable size, generate an encoding stream by performing encoding using motion compensation and quantization, and thereby record the input image.

A video input unit 101 receives input of a video signal from an image capturing apparatus and outputs the image signal to a first block dividing unit 102 (first dividing unit). The first block dividing unit 102 divides a coding target image of input video signals into multiple first block images of variable size. The dividing method will be described in detail later. An adder 103, in accordance with control (described later) performed by a block size determination unit 114, calculates prediction differences between pixel values of the input block image and reference pixel values used for prediction. An orthogonal transformation unit 104 transforms the prediction differences into discrete cosine coefficients, for example. A quantization unit 105 quantizes the discrete cosine coefficients.

An inverse quantization unit 106 and an inverse orthogonal transformation unit 107 determine the prediction differences from the reference pixel values by performing inverse quantization and inverse orthogonal transformation on the quantization result obtained by the quantization unit 105. An adder 108 adds the prediction difference and the reference pixel value together and thereby obtains a pixel value that is a local decoding result. The pixel values obtained by the adder 108 are held in a reference frame holding unit 109.

A motion search unit 110 (motion vector detecting unit) performs pattern matching using the first block image and reference pixel values of a previous image that is held in the reference frame holding unit 109. Then, as the motion vector of the first block image in the input image (coding target image), the motion search unit 110 detects the vector with which the differences from the reference pixel values are the smallest. The motion vector of the first block image that was detected by the motion search unit 110 is output to a motion compensation unit 115.

The second block dividing unit 111 (second dividing unit) furthermore divides the input first block image into multiple smaller second block images and outputs them to the variance value calculation unit 112. The variance value calculation unit 112 calculates variance values for the input second block images and outputs them to the characteristic amount calculation unit 113.

The characteristic amount calculation unit 113 uses the variance values input by the variance value calculation unit 112 to calculate characteristic amounts (hereinafter referred to as “deterioration levels”) that indicate the noticeability of image quality deterioration caused by quantizing the second block images, and outputs the characteristic amounts to a block size determination unit 114. Visual deterioration in regions having high variance values generally tends not to be noticeable, but visual deterioration in regions having low variance values generally tends to be noticeable. Therefore, the characteristic amount calculation unit 113 calculates a low value for the deterioration level of regions having high variance values, and a high value for the deterioration level of regions having low variance values.

The block size determination unit 114 uses the deterioration level output from the characteristic amount calculation unit 113 to select whether to use the first block image or the second block image as the encoding size (unit). The block size determination unit 114 controls the operation of the adder 103 and the motion compensation unit 115 by notifying the adder 103 and the motion compensation unit 115 of the selection result. The selection method will be described in detail later.

The motion compensation unit 115 acquires the motion vectors detected by the motion search unit 110 and, in accordance with an instruction from the block size determination unit 114, outputs the first block image pixel values or the second block image pixel values indicated by the motion vectors in the reference image as the reference pixel value. Then, in accordance with the instruction from the block size determination unit 114, the adder 103 uses the reference pixel values from the motion compensation unit 115 to calculate the differences between the pixel values of the first block image or the second block image in a subsequent frame or field and the selected reference pixel values. With this, subsequent encoding is executed. That is to say, the encoding of the multiple second block images or the first block image is executed according to the selection performed by the block size determination unit 114.

An entropy encoding unit 116 performs entropy encoding on the result of quantization performed by the quantization unit 105 and the motion vectors obtained by the motion search unit 110 and outputs the result as a stream to a recording medium 117.

Note that the moving image encoding apparatus 100 may furthermore include an image capturing unit that captures a coding target image that is to be input to the video input unit 101. In that case, the moving image encoding apparatus 100 functions as an image capturing apparatus.

The method for dividing the coding target image in the first block dividing unit 102 will be described next in detail. In the present embodiment, the sizes of the first block images are variable, and it is possible to select 32 pixels×32 pixels, 16 pixels×16 pixels, 16 pixels×8 pixels, 8 pixels×8 pixels, or the like as the size, for example.

FIG. 2 is a diagram for describing the first block images. The left-side drawing in FIG. 2 shows a coding target image, and the right-side drawing in FIG. 2 shows a state in which the coding target image is divided into multiple first block images. Although there are blocks of various sizes in the right-side drawing in FIG. 2, they are all first block images. In this way, the first block dividing unit 102 divides the coding target image into multiple first block images of variable size.

Note that the size of each first block image may be a fixed size. Also, in the case of using variable sizes, the sizes can be set using a variety of methods, and as an example, the first block dividing unit 102 can determine the block image sizes by grouping pixels together that have a small difference from adjacent pixel values.

The method for dividing the first block images in the second block dividing unit 111 will be described next in detail.

FIG. 3 is a diagram for describing the second block images. The left side of FIG. 3 shows a state in which the coding target image is divided into the multiple first block images, and the right side of FIG. 3 shows a state in which a first block image 301 is divided into multiple second block images. In the present embodiment, the second block dividing unit 111 divides the first block image into two images vertically and two images horizontally. For example, the second block dividing unit 111 divides the first block image 301, which is one of the multiple first block images, into four second block images 311, 312, 313, and 314.

The encoding processing performed by the moving image encoding apparatus 100, and in particular, the method for selecting the block image in the block size determination unit 114 will be described next in detail. FIG. 4 is a flowchart showing the encoding processing performed by the moving image encoding apparatus 100.

In step S401, the first block dividing unit 102 divides the coding target image into the multiple first block images as described above with reference to FIG. 2. In step S402, the motion search unit 110 detects the motion vector of the first block image. In step S403, the second block dividing unit 111 divides the first block image into the multiple second block images as described above with reference to FIG. 3.

In step S404, the variance value calculation unit 112 calculates, for each of the multiple second block images, the variance value of the pixel values. Then, the characteristic amount calculation unit 113 calculates the deterioration levels (characteristic amounts indicating the noticeability of image quality deterioration caused by quantization) for the second block images.

In step S405, the block size determination unit 114 determines whether or not the deterioration levels of the second block images are close to each other. If the deterioration levels are close to each other, the procedure moves to the processing of step S406, and if they are not, the procedure moves to the processing of step S407. The determination in step S405 is performed by determining whether or not the degree of variation among the deterioration levels is at or above a threshold value, for example. If the degree of variation among the deterioration levels is at or above the threshold value, the block size determination unit 114 determines that the deterioration levels are not close to each other, and if the degree of variation is below the threshold value, the block size determination unit 114 determines that the deterioration levels are close to each other.

In step S406, the block size determination unit 114 selects the first block image and performs notification of the selection to the adder 103 and the motion compensation unit 115. In step S407, the block size determination unit 114 selects the second block images and performs notification of the selection to the adder 103 and the motion compensation unit 115.

In step S408, the moving image encoding apparatus 100 encodes the block image(s) selected in step S406 or S407 using the adder 103, the motion compensation unit 115, the orthogonal transformation unit 104, the quantization unit 105, and the like. If the second block images have been selected, the motion compensation unit 115 uses the motion vector (i.e., the motion vector detected in step S402) of the first block image that corresponds to those second block images as the motion vector of each of the block images.

The processing of steps S404 to S408 will be described next in further detail with reference to FIG. 5. In FIG. 5, reference numeral 501 indicates a coding target image. Reference numeral 502 indicates a first block image. Reference numeral 503 indicates a second block image that has been obtained by dividing the first block image 502. Reference numeral 504 indicates a first block image that is different from the first block image 502. Reference numeral 505 indicates a second block image that has been obtained by dividing the first block image 504. Reference numeral 506 indicates the motion vector of the first block image 502 that was detected by the motion search unit 110. Reference numeral 507 indicates the motion vector of the first block image 504 that was detected by the motion search unit 110.

A flat region and a complex region are both present in the first block image 502. Accordingly, second block images 503 having high and low deterioration levels are obtained from the first block image 502. Accordingly, the block size determination unit 114 determines that the deterioration levels are not close to each other, and the second block images 503 are selected. In this case, the motion compensation unit 115 acquires the motion vector 506 of the first block image 502 that was detected by the motion search unit 110 and the motion vector is used as the motion vector of each of the second block images 503.

On the other hand, only flat regions are included in the first block image 504. Accordingly, only second block images 505 having low deterioration levels are obtained from the first block image 504. Accordingly, the block size determination unit 114 determines that the deterioration levels are close to each other, and the first block image 504 is selected. In this case, the motion compensation unit 115 acquires the motion vector 507 of the first block image 504 that was detected by the motion search unit 110 and the motion vector is used to perform motion compensation.

As described above, according to the present embodiment, the moving image encoding apparatus 100 divides a first block image obtained from a coding target image into multiple second block images and calculates the deterioration levels of the second block images. Then, if the deterioration levels are close to each other, the moving image encoding apparatus 100 encodes the first block image, and if not, it encodes the second block images.

Accordingly, in the case where the deterioration levels are close to each other, the number of motion vectors is reduced since the first block image, which is larger in size than the second block images, is selected, and in such a case, even if the entirety of the first block image is quantized using a uniform quantization step, image quality deterioration is not likely to be noticeable. Also, in the case where the deterioration levels are not close to each other, image quality deterioration is suppressed since the second block images, which are smaller in size than the first block image, are selected and the quantization steps are determined individually for the respective second block images. As a result, it is possible to reduce the number of motion vectors while suppressing image quality deterioration when encoding using motion compensation and quantization.

### Second Embodiment

FIG. 6 is a block diagram showing a configuration of a moving image encoding apparatus 600 according to a second embodiment. Constituent elements that are the same or similar to those in the moving image encoding apparatus 100 in FIG. 1 are denoted by the same reference numerals in FIG. 6, and the description will not be repeated here. In the first embodiment, the moving image encoding apparatus 100 used the motion vector of the first block image as the motion vector of a second block image, but in the second embodiment, the moving image encoding apparatus 600 detects the motion vectors of the second block images as well.

A motion search unit 601 detects the motion vectors of the first block images, similarly to the motion search unit 110. Additionally, the motion search unit 601 acquires the second block images from the second block dividing unit 111 and detects the motion vectors of the second block images as well. The motion vectors of the detected first and second block images are held in the motion vector holding unit 602.

If a first block image is selected by the block size determination unit 114, the motion compensation unit 603 acquires the motion vector of the first block image from the motion vector holding unit 602 and performs motion compensation using the motion vector. On the other hand, if multiple second block images are selected by the block size determination unit 114, the motion compensation unit 603 acquires the motion vectors of the second block images from the motion vector holding unit 602 and performs motion compensation using these motion vectors.

Accordingly, in the second embodiment, if encoding is performed in accordance with the flowchart in FIG. 4, the moving image encoding apparatus 600 detects the motion vectors of the second block images in addition to the motion vectors of the first block images in step S402. Also, if the second block images are selected in step S407, the moving image encoding apparatus 600 performs encoding in step S408 using the motion vectors of the second block images that were detected in step S402.

A specific example of the encoding processing according to the second embodiment will be described below with reference to FIGS. 7 and 8. FIG. 7 is a diagram for describing motion vector detection processing performed by the motion search unit 601. In FIG. 7, reference numeral 701 indicates a first block image of the coding target image, and reference numeral 702 indicates a second block image obtained from the first block image 701. Reference numeral 703 indicates a reference image, reference numeral 704 indicates the motion vector of the first block image 701, and reference numeral 705 indicates the motion vectors of the four second block images.

The motion search unit 601 detects the first motion vector 704 by performing pattern matching on the input first block image 701 and the reference image 703 and outputs it to the motion vector holding unit 602. Also, the motion search unit 601 calculates the second motion vectors 705 for the four input second block images 702 by performing pattern matching on the reference image 703 and outputs the motion vectors to the motion vector holding unit 602.

FIG. 8 will be used next as a reference. In FIG. 8, reference numerals 501 to 506 represent the same elements as reference numerals 501 to 506 in FIG. 5. Reference numeral 806 represents the motion vectors of the four second block images 503 that were detected by the motion search unit 601. Unlike the case of the first embodiment (see FIG. 5), in the second embodiment, if the second block images 503 are selected, the motion compensation unit 603 acquires the motion vectors of the second block images 503 that were detected by the motion search unit 601 and encoding is performed.

As described above, according to the second embodiment, the moving image encoding apparatus 600 detects the motion vectors of the second block images as well. Accordingly, the accuracy of motion compensation improves, and the image quality in the case of encoding the second block images improves.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-054131, filed Mar. 15, 2013, which is hereby incorporated by reference herein in its entirety.

What is claimed is:

1. A moving image encoding apparatus configured to perform encoding using motion compensation and quantization, the moving image encoding apparatus comprising:
a first dividing unit configured to divide a coding target image into a plurality of first block images;
a motion vector detecting unit configured to detect a motion vector of the first block image;
a second dividing unit configured to divide the first block image into a plurality of second block images;
a characteristic amount calculating unit configured to calculate, for each of the plurality of second block images, a characteristic amount that indicates noticeability of image quality deterioration caused by quantization;
a selecting unit configured to, if a degree of variation in the characteristic amounts of the plurality of second block images is greater than or equal to a threshold value, select the plurality of second block images, and if not, select the first block image; and
an encoding unit configured to encode the plurality of second block images or the first block image in accordance with the selection performed by the selecting unit.

2. The moving image encoding apparatus according to claim 1,
wherein, if the plurality of second block images are to be encoded, the encoding unit performs motion compensation using the motion vector of the first block image that corresponds to the plurality of second block images as a motion vector of each second block image.

3. The moving image encoding apparatus according to claim 1,
wherein the motion vector detecting unit detects a motion vector of each of the plurality of second block images, and
if the plurality of second block images are to be encoded, the encoding unit performs motion compensation using the motion vectors of the second block images detected by the motion vector detecting unit.

4. The moving image encoding apparatus according to claim 1,
wherein the characteristic amount calculating unit calculates, as the characteristic amount, a value that is based on variance in pixel values of the second block image.

5. The moving image encoding apparatus according to claim 1,
wherein the first dividing unit divides the coding target image into the plurality of first block images of a plurality of sizes.

6. An image capturing apparatus comprising:
the moving image encoding apparatus according to claim 1; and
an image capturing unit configured to capture the coding target image.

7. A moving image encoding apparatus configured to perform encoding using motion compensation and quantization, the moving image encoding apparatus comprising:
a first dividing unit configured to divide a coding target image into a plurality of first block images;
a second dividing unit configured to divide the first block image into a plurality of second block images;
a characteristic amount calculating unit configured to, for each of the plurality of second block images, calculate a characteristic amount of an image;
a size determining unit configured to determine whether to use a size of the first block image or a size of the second block image as an encoding size of the first block image; and
an encoding unit configured to encode the first block image using the size of the first block image or the size of the second block image in accordance with the determination by the size determining unit,
wherein, based on the characteristic amounts of the plurality of second block images calculated by the characteristic amount calculating unit, if each of the plurality of second block images is a flat region, the size determining unit determines the size of the first block image as the encoding size of the first block image.

8. The moving image encoding apparatus according to claim 7, further comprising:
a motion vector detecting unit configured to detect a motion vector of the first block image;
wherein, if the first block image is to be encoded using the size of the second block image, the encoding unit performs motion compensation using the motion vector of the first block image.

9. The moving image encoding apparatus according to claim 7, further comprising:
a first motion vector detecting unit configured to detect a motion vector of the first block image; and
a second motion vector detecting unit configured to detect motion vectors of the plurality of second block images,
wherein, if the first block image is to be encoded using the size of the first block image, the encoding unit performs motion compensation using the motion vector detected by the first motion vector detecting unit, and if the first block image is to be encoded using the size of the second block image, the encoding unit performs motion compensation using the motion vectors detected by the second motion vector detecting unit.

10. The moving image encoding apparatus according to claim 7,
wherein the characteristic amount calculating unit calculates, as the characteristic amount, a value that is based on variance in pixel values of the second block image.

11. A moving image encoding apparatus configured to perform encoding using motion compensation and quantization, the moving image encoding apparatus comprising:
a first dividing unit configured to divide a coding target image into a plurality of first block images;
a second dividing unit configured to divide the first block image into a plurality of second block images;
a characteristic amount calculating unit configured to, for each of the plurality of second block images, calculate a characteristic amount of an image;
a size determining unit configured to determine whether to use a size of the first block image or a size of the second block image as an encoding size of the first block image; and
an encoding unit configured to encode the first block image using the size of the first block image or the size of the second block image in accordance with the determination by the size determining unit,
wherein, based on the characteristic amounts of the plurality of second block images calculated by the characteristic amount calculating unit, if the plurality of second block images include a flat region and a complex region, the size determining unit determines the size of the second block image as the encoding size of the first block image.

12. The moving image encoding apparatus according to claim 11, further comprising:
a motion vector detecting unit configured to detect a motion vector of first block image;
wherein, if the first block image is to be encoded using the size of the second block image, the encoding unit performs motion compensation using the motion vector of the first block image.

13. The moving image encoding apparatus according to claim 11, further comprising:
a first motion vector detecting unit configured to detect a motion vector of the first block image; and
a second motion vector detecting unit configured to detect motion vectors of the plurality of second block images,
wherein, if the first block image is to be encoded using the size of the first block image, the encoding unit performs motion compensation using the motion vector detected by the first motion vector detecting unit, and if the first block image is to be encoded using the size of the second block image, the encoding unit performs motion compensation using the motion vectors detected by the second motion vector detecting unit.

14. The moving image encoding apparatus according to claim 11,
wherein the characteristic amount calculating unit calculates, as the characteristic amount, a value that is based on variance in pixel values of the second block image.

15. A method for controlling a moving image encoding apparatus configured to perform encoding using motion compensation and quantization, the method comprising:
a first dividing step of dividing a coding target image into a plurality of first block images;
a motion vector detecting step of detecting a motion vector of the first block image;
a second dividing step of dividing the first block image into a plurality of second block images;
a characteristic amount calculating step of, for each of the plurality of second block images, calculating a characteristic amount that indicates noticeability of image quality deterioration caused by quantization;
a selecting step of, if a degree of variation in the characteristic amounts of the plurality of second block images is greater than or equal to a threshold value, selecting the plurality of second block images, and if not, selecting the first block image; and
an encoding step of encoding the plurality of second block images or the first block image in accordance with the selection in the selecting step.

16. A non-transitory computer-readable storage medium for storing a program to cause a computer to execute the method according to claim 15.

17. A method for controlling a moving image encoding apparatus configured to perform encoding using motion compensation and quantization, the method comprising:
a first dividing step of dividing a coding target image into a plurality of first block images;
a second dividing step of dividing the first block image into a plurality of second block images;
a characteristic amount calculating step of, for each of the plurality of second block images, calculating a characteristic amount of an image;
a size determining step of determining whether to use a size of the first block image or a size of the second block image as an encoding size of the first block image; and
an encoding step of encoding the first block image using the size of the first block image or the size of the second block image in accordance with the determination in the size determining step,
wherein in the size determining step, based on the characteristic amounts of the plurality of second block images calculated in the characteristic amount calculating step, if each of the plurality of second block images is a flat region, the size of the first block image is determined as the encoding size of the first block image.

18. A non-transitory computer-readable storage medium for storing a program to cause a computer to execute the method according to claim 17.

19. A method for controlling a moving image encoding apparatus configured to perform encoding using motion compensation and quantization, the method comprising:
a first dividing step of dividing a coding target image into a plurality of first block images;
a second dividing step of dividing the first block image into a plurality of second block images;
a characteristic amount calculating step of, for each of the plurality of second block images, calculating a characteristic amount of an image;
a size determining step of determining whether to use a size of the first block image or a size of the second block image as an encoding size of the first block image; and
an encoding step of encoding the first block image using the size of the first block image or the size of the second block image in accordance with the determination in the size determining step,
wherein in the size determining step, based on the characteristic amounts of the plurality of second block images calculated in the characteristic amount calculating step, if the plurality of second block images include a flat region and a complex region, the size of the second block image is determined as the encoding size of the first block image.

20. A non-transitory computer-readable storage medium for storing a program to cause a computer to execute the method according to claim 19.
